(19) United States
(12) Patent Application Publication
(10) Pub. No.: US 2022/0380050 A1
(43) Pub. Date: Dec. 1, 2022

(54) Aircraft Cargo Hold Unloading and Collection System

(71) Applicant: Shanghai Autoflight Co., Ltd., Kunshan City (CN)

(72) Inventor: Yu Tian, Hong Kong SAR (CN)

(21) Appl. No.: 17/827,443

(22) Filed: May 27, 2022

(30) Foreign Application Priority Data
May 27, 2021 (CN) 202121159501.6

(51) Int. Cl. B64D 1/12; B64C 39/02; B64D 9/00; B64F 1/32

(52) U.S. Cl. CPC B64D 1/12; B64C 39/024; B64D 9/003; B64F 1/32; B64C 2201/128

(57) ABSTRACT

An aircraft cargo hold unloading and collection system having an aircraft body, a lifting device, and a netted shelf. The lifting device is arranged on the aircraft body, and the lifting device is connected to the aircraft body through communication. The lifting device has a retractable cable. One end of the cable can be connected to the cargo hold, and the other end is fixed relative to the aircraft body. The netted shelf is used to be arranged on the ground, and the aircraft body is provided with a position identification part. The netted shelf is provided with a trigger part, and the position identification part can identify the signal transmitted from the trigger part to locate the netted shelf.

### TECHNICAL FIELD

The application relates to the technical field of aircraft, in particular to an aircraft cargo hold unloading and collection system.

### BACKGROUND ART

At present, more and more aircraft such as unmanned aerial vehicle (UAV) have been used in logistics, disaster relief, agriculture and other fields, and the unloading and collection of cargo hold carried by aircraft is a key problem in aircraft application. In the prior art, when unloading and collection of the cargo hold is carried by the aircraft, the following two methods are usually adopted: 1. The aircraft lands on the ground and the cargo hold carried by the aircraft is manually unloaded and collected; 2. The parachute is connected to the cargo hold, and the aircraft drops the cargo hold to the ground by parachute, and then the cargo hold will be collected manually. For the first mode, the aircraft needs to land and take off again every time when it unloads and collects the cargo hold, resulting in a significant reduction in the transportation and collection efficiency of the cargo hold. For the second mode, by parachute landing, it is difficult to ensure both the safety of the cargo hold and the actual landing position of the cargo hold. Further manual collection will be needed later.

Therefore, there is an urgent need for an aircraft cargo hold unloading and collection system to solve the above technical problems.

### SUMMARY OF THE APPLICATION

The purpose of the application is to propose an aircraft cargo tank unloading and collection system, which can achieve the unloading and collection of the cargo tank without landing of the aircraft body, and can ensure the accuracy of the unloading and collection position of the cargo tank and the safety of the cargo tank.

In order to achieve this purpose, the application adopts the following technical solution: an aircraft cargo tank unloading and collection system, which comprises: an aircraft body, including a position identification part;

A lifting device arranged on the aircraft body and connected to the aircraft body through communication, the lifting device comprises a retractable cable, and one end of the cable can be connected to a cargo hold;

A netted shelf is configured to be arranged on the ground, the netted shelf is provided with a trigger component, and the position identification part can identify the signal sent by the trigger component to locate the netted shelf.

The netted shelf comprises:

A bracket configured to support the ground;

A net bag is connected to the bracket, and the net bag is arranged at intervals with the ground.

The bracket comprises a lower support seat, an upper support seat and at least three legs, the lower support seat is configured to be arranged on the ground, the net bag is connected to the upper support seat, the lower end of the leg is movably connected with the lower support seat, the upper end of the leg is movably connected with the upper support seat, and the length of the legs is adjustable.

The upper support seat is circular-ring shape.

The position identification part is a network server, the trigger part is a GPS module, which can locate the position of the netted shelf and connect with the network server through communication.

The trigger part is a laser transmitter, and the position recognition part is a laser receiver, which can recognize the signal from the laser transmitter.

The aircraft body is a UAV.

The lifting device also includes a clamping claw, which is arranged at the end of the cable and electrically connected with the aircraft body, and can clamp and release the cargo hold.

The cable is internally provided with wire, which is used to electrically connect the clamping claw and the aircraft body.

The lifting device also includes a winch mechanism, the winch mechanism is arranged on the aircraft body, and the cable is connected to the output end of the winch mechanism.

The beneficial effects of the application are as follows:

In the aircraft cargo hold unloading and collection system of the application, the aircraft body hovers at low altitude, and the cable is retracted and released through the lifting device to drive the lifting movement of the cargo hold, so as to complete the process of loading the cargo hold on the aircraft body and unloading the cargo hold from the aircraft body to the ground without landing the aircraft directly on the ground, thereby improving the work efficiency. When the cargo hold is unloaded and collected from the aircraft body, the position identification part on the aircraft body can identify the signal transmitted from the trigger part on the netted shelf, so that the aircraft body can accurately identify the position of the netted shelf and hover over the netted shelf, and then accurately place the cargo hold on the netted shelf for collection, which can not only avoid the collision of the cargo hold and improve the safety of the cargo, but also ensure that the cargo hold can be collected centrally at the preset position to reduce the subsequent workload of the staff.

### DESCRIPTION OF THE FIGURE(S)

FIG. 1 is the structural diagram of the aircraft cargo hold unloading and collection system provided by the specific embodiment of the application.

Wherein,

1—Aircraft body; 2—Cable; 3—Cargo hold; 4—netted shelf; 41—Bracket; 411—Lower support seat; 412—Upper support seat; 413—Leg; 42—Net bag.

### DETAILED DESCRIPTION

The application is further described below in combination with the drawings and the embodiments. It can be understood that the specific embodiments described here are only used to explain the application, rather than to limit the application. In addition, it should be noted that for the convenience of description, only some parts related to the application are shown in the drawings, not all.

In the description of the application, it should be noted that unless otherwise specified and limited, the terms, “connect”, “connection”, and “fixation” should be understood in a broad sense. For example, it can be fixedly connected, detachably connected, or integrated. It can be mechanical connection or electrical connection. It can be connected directly or indirectly through an intermediate medium, and it can be the connection between the two components. For those skilled in the art, the specific meaning of the above terms in the application can be understood in specific circumstances.

In the application, unless otherwise clearly specified and limited, the first feature “on” or “under” the second feature may include the direct contact between the first and second features, or the contact between the first and second features that is not direct contact, but through another feature between them. Moreover, the first feature “on”, “over”, and “above” the second feature may include the first feature directly above and obliquely above the second feature, or only indicates that the horizontal height of the first feature is higher than the second feature. The first feature “under”, “below” and “beneath” the second feature, may include the first feature directly below and obliquely below the second feature, or only indicate that the horizontal height of the first feature is smaller than that of the second feature.

In the description of this embodiment, the terms “up”, “down”, “right” and other orientation or position relationship are based on the orientation or position relationship shown in the drawings, only for the convenience of description and simplified operation, rather than indicating or implying that the device or element must have a specific orientation, be constructed and operated in a specific orientation, so it cannot be understood as a limitation on the application. In addition, the terms “first” and “second” are only used to distinguish in description but have no special meaning.

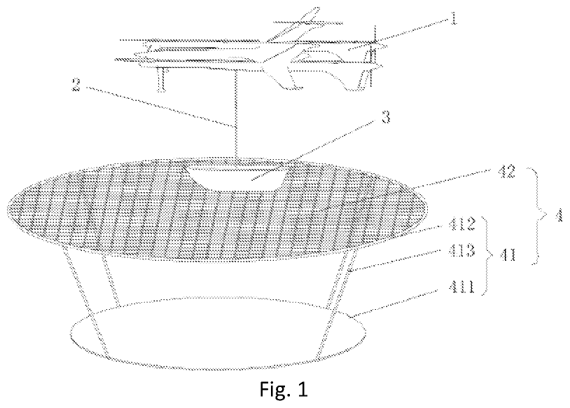

This embodiment provides an aircraft cargo hold unloading and collection system. As shown in FIG. 1, the aircraft cargo hold unloading and collection system comprises an aircraft body 1, a lifting device and a netted shelf 4. The lifting device is arranged on the aircraft body 1, and the lifting device is connected to the aircraft body 1 through communication. The lifting device comprises a retractable cable 2, of which one end can be connected to the cargo tank 3 and the other end is fixed relative to the aircraft body 1. The netted shelf 4 is used to be arranged on the ground. The aircraft body 1 is provided with a position identification part, and the netted shelf 4 is provided with a trigger part. The position identification part can identify the signal transmitted from the trigger part to locate the netted shelf 4.

In the aircraft cargo hold unloading and collection system, the aircraft body 1 hovers at low altitude, and the cable 2 is retracted and released through the lifting device to drive the lifting and lowering movement of the cargo hold 3, so as to complete the process of loading the cargo hold 3 on the aircraft body 1 and unloading the cargo hold 3 from the aircraft body 1 to the ground without landing the aircraft directly on the ground, thereby improving the work efficiency. When the cargo hold 3 on the aircraft body 1 is unloaded, the netted shelf 4 is firstly arranged at the preset position for the collection of the cargo hold 3, and the position identification part on the aircraft body 1 will identify the signal transmitted from the trigger part on the netted shelf 4, so that the aircraft body 1 can accurately identify the position of the netted shelf 4 and hover above the netted shelf 4, so that the aircraft body 1 can accurately place the cargo tank 3 on the netted shelf 4 for collection. In this way, it can not only avoid the collision of cargo hold 3 and improve the safety of cargo, but also ensure that the cargo hold 3 can be collected centrally at the preset position to reduce the subsequent workload of staff.

In this embodiment, the aircraft body 1 is a UAV, and in other embodiments, the aircraft may also be any existing aircraft. In this embodiment, there is no storage space inside the aircraft body 1, and the aircraft body 1 can only carry one cargo hold 3 through the cable 2. In other embodiments, the aircraft body 1 is provided with a storage space in which a plurality of cargo holds 3 can be placed, in which case the staff can enter the storage space and fix the cargo hold 3 at one end of the cable 2, and then the lifting device can lower the cable 2 to unload the cargo hold 3 onto the netted shelf 4 for collection. Repeating the above process for many times can complete the unloading and collection of the plurality of cargo holds 3.

The position identification part is a network server, and the trigger part is a GPS module. The GPS module can locate the position of the netted shelf 4 and connect to the network server through communication. After the network server obtains the signal transmitted from the GPS module, it will obtain the accurate location of the netted shelf 4 and enable the aircraft body 1 to hover over the netted shelf 4 at low altitude. At this time, the aircraft body 1 will notify that the lifting device has been over the netted shelf 4, and instruct the lifting device to lower the cable 2 to facilitate loading/collecting the cargo hold 3 on the netted shelf 4. It can be understood that on the basis of not violating the invention concept of the present application, the GPS module can be any one of the prior art, which is not specifically limited here.

In other embodiments, the trigger part is a laser transmitter and the position identification part is a laser receiver. When it is necessary to unload and collect the cargo hold 3, the aircraft body 1 first flies over the position near the netted shelf 4, and the laser transmitter transmits the laser signal upward. When the laser receiver recognizes the laser signal transmitted from the laser transmitter, it indicates that the aircraft body 1 has reached the accurate position. At this time, the lifting device lowers the cable 2 to ensure that the cargo hold 3 accurately falls on the netted shelf 4, thus guaranteeing the safety of the cargo hold 3. In another embodiment, the position identification part and the trigger part can also be other combinations, as long as the accurate positioning of the aircraft body 1 and the netted shelf 4 can be realized, which is not limited here.

As shown in FIG. 1, the netted shelf 4 comprises a bracket 41 and a net bag 42. The netted shelf 4 is arranged on the ground, the net bag 42 is supported on the bracket 41 and arranged at intervals from the ground, and the cargo hold 3 is placed on the net bag 42 by the cable 2 without direct contacting with the ground, so as to avoid rigid collision of the cargo hold 3, ensure the safety of the cargo hold 3, and ensure the cleanness of the cargo hold 3. In this embodiment, due to the moderate deformation capacity of the net bag 42, it is necessary to ensure that it can offer certain buffer effect to the cargo hold 3 on it, and avoid the issue of the net bag sweeping the floor once the cargo hold 3 is placed on the net bag 42.

As shown in FIG. 1, the bracket 41 comprises a lower support seat 411, an upper support seat 412 and at least three legs 413. The lower support seat 411 is arranged on the ground, the net bag 42 is connected to the upper support seat 412, the lower end of the leg 413 is movably connected to the lower support seat 411, the upper end of the leg 413 is movably connected to the upper support seat 412, and the length of the leg 413 is adjustable. When the ground has a certain slope, the length of each leg 413 may be adjusted to keep the net bag 42 horizontal, so as to prevent the cargo hold 3 from falling from the net bag 42. In this embodiment, the bracket 41 comprises four legs 413. The legs 413 may be telescopic rods or other structures that can adjust length change, which is not limited here.

As shown in FIG. 1, the upper support seat 412 is circular-ring shape, so that the net bag 42 is circular to facilitate the aircraft body 1 to hover in the center of the netted shelf 4. In other embodiments, the upper support seat 412 can also be square or other shapes, which is not limited here. When the trigger part is a GPS module, the GPS module may be arranged at the center of the lower support seat 411 or at other position of the netted shelf 4, both of which can ensure that the position identification part can receive the signal of the trigger part. When the trigger part is a laser transmitter, the laser transmitter is arranged on the upper support seat, so as to prevent the laser transmitted from the laser transmitter from being blocked by the cargo hold 3 placed on the net bag 42.

The lifting device also comprises a winch mechanism, which is arranged on the aircraft body 1. The cable 2 is connected to the output end of the winch mechanism, that is, one end of the cable 2 is fixed on the drum of the winch mechanism. When the drum of the winch mechanism rotates, the cable 2 achieves the winding or lowering action. Further, the lifting device also comprises a clamping claw, which is arranged at the end of the cable 2 and electrically connected with the aircraft body 1. The clamping claw can clamp and release the cargo hold 3. When it is necessary to load the cargo hold 3 onto the aircraft body 1, it can first align the cargo hold 3 through the manual auxiliary chuck, and then the aircraft body 1 controls the clamping claw action to clamp and fix the cargo hold 3. As for the unloading of the cargo hold 3, when the cargo hold 3 falls on the net bag 42, the aircraft body 1 will drive the clamping to act and release the cargo hold 3, so as to achieves the automatic unloading of the cargo hold 3. The clamping claw may directly clamp the whole cargo hold 3 or the lifting ring structure on the cargo hold 3, which is not limited here. On the basis of not violating the invention concept of the application, the clamping claw may be any one of the prior art, which is not specifically limited here.

Further, the cable 2 is internally provided with wire, which is used to electrically connect the clamping claw and the aircraft body 1. The arrangement of wire within the cable 2 not only meets the electrical connection between the clamping claw and the aircraft body 1, but also reduces the external winding, thereby avoiding the entanglement between the wire and the cargo hold 3, and improving the safety of the aircraft cargo hold unloading and collection system.

Obviously, the above embodiments of the application are only given to clearly illustrate the examples given by the application, rather than to limit the embodiment of the application. For those skilled in the art, depending upon the idea of the application, there may be changes in the specific embodiments and application scope. The contents of the specifications should not be understood as restrictions on the application. Any modification, equivalent replacement and improvement made based on the spirit and principles of the application shall fall within the breadth and scope of the claims of the application.

1. An aircraft cargo hold unloading and collection system, which is characterized by comprising:
an aircraft body (1), including a position identification part;
a lifting device, which is arranged on the aircraft body (1) and connected to the aircraft body (1) through communication, and comprises a retractable cable (2), one end of which can be connected to a cargo hold (3);
a netted shelf (4), which is configured to be arranged on the ground. The netted shelf (4) is provided with a trigger part, and the position identification part can identify the signal transmitted from the trigger part to locate the netted shelf (4).

2. An aircraft cargo hold unloading and collection system according to claim 1, which is characterized in that the netted shelf (4) comprises:
a bracket (41), which is configured to be supported on the ground;
a net bag (42), which is connected to the bracket (41), and is arranged at intervals from the ground.

3. An aircraft cargo hold unloading and collection system according to claim 2, which is characterized in that the bracket (41) comprises a lower support seat (411), an upper support seat (412) and at least three legs (413). The lower support seat (411) is configured to be arranged on the ground, the net bag (42) is connected to the upper support seat (412), and the lower end of the legs (413) is movably connected to the lower support seat (411). The upper end of the leg is movably connected to the upper support seat (412), and the length of the legs (413) is adjustable.

4. An aircraft cargo hold unloading and collection system according to claim 3, which is characterized in that the upper support seat (412) is circular-ring shape.

5. An aircraft cargo hold unloading and collection system according to claim 1, which is characterized in that the position identification part is a network server, the trigger part is a GPS module, which can locate the position of the netted shelf (4) and connected to the network server through communication.

6. An aircraft cargo hold unloading and collection system according to claim 2, which is characterized in that the position identification part is a network server, the trigger part is a GPS module, which can locate the position of the netted shelf (4) and connected to the network server through communication.

7. An aircraft cargo hold unloading and collection system according to claim 3, which is characterized in that the position identification part is a network server, the trigger part is a GPS module, which can locate the position of the netted shelf (4) and connected to the network server through communication.

8. An aircraft cargo hold unloading and collection system according to claim 1, which is characterized in that the trigger part is a laser transmitter, and the position identification part is a laser receiver, which can recognize the signal of the laser transmitter.

9. An aircraft cargo hold unloading and collection system according to claim 2, which is characterized in that the trigger part is a laser transmitter, and the position identification part is a laser receiver, which can recognize the signal of the laser transmitter.

10. An aircraft cargo hold unloading and collection system according to claim 3, which is characterized in that the trigger part is a laser transmitter, and the position identification part is a laser receiver, which can recognize the signal of the laser transmitter.

11. An aircraft cargo hold unloading and collection system according to claim 1, which is characterized in that the aircraft body (1) is a UAV (unmanned aerial vehicle).

12. An aircraft cargo hold unloading and collection system according to claim 2, which is characterized in that the aircraft body (1) is a UAV (unmanned aerial vehicle).

13. An aircraft cargo hold unloading and collection system according to claim 3, which is characterized in that the aircraft body (1) is a UAV (unmanned aerial vehicle).

14. An aircraft cargo hold unloading and collection system according to claim 1, which is characterized in that the lifting device further comprises a clamping claw, which is arranged at the end of the cable (2) and electrically connected with the aircraft body (1), and the clamping claw can clamp and release the cargo tank (3).

15. An aircraft cargo hold unloading and collection system according to claim 2, which is characterized in that the lifting device further comprises a clamping claw, which is arranged at the end of the cable (2) and electrically connected with the aircraft body (1), and the clamping claw can clamp and release the cargo tank (3).

16. An aircraft cargo hold unloading and collection system according to claim 3, which is characterized in that the lifting device further comprises a clamping claw, which is arranged at the end of the cable (2) and electrically connected with the aircraft body (1), and the clamping claw can clamp and release the cargo tank (3).

17. An aircraft cargo hold unloading and collection system according to claim 8, which is characterized in that a wire is threaded inside the cable (2), and the wire is used to electrically connect the clamping claw and the aircraft body (1).

18. An aircraft cargo hold unloading and collection system according to claim 1, which is characterized in that the lifting device further comprises a winch mechanism, which is arranged on the aircraft body (1), and the cable (2) is connected to the output end of the winch mechanism.

19. An aircraft cargo hold unloading and collection system according to claim 2, which is characterized in that the lifting device further comprises a winch mechanism, which is arranged on the aircraft body (1), and the cable (2) is connected to the output end of the winch mechanism.

20. An aircraft cargo hold unloading and collection system according to claim 4, which is characterized in that the lifting device further comprises a winch mechanism, which is arranged on the aircraft body (1), and the cable (2) is connected to the output end of the winch mechanism.
